(19) United States
(12) Patent Application Publication
(10) Pub. No.: US 2021/0331014 A1
(43) Pub. Date: Oct. 28, 2021

(54) A LOW-PRESSURE MIST FIRE EXTINGUISHING DEVICE AND A SET OF COMPONENTS FOR A LOW-PRESSURE MIST FIRE EXTINGUISHING DEVICE

(71) Applicant: FIREMIST SP. Z.O.O., Radom (PL)

(72) Inventors: Jerzy SWIDERSKI, Warzawa (PL); Wojciech GALEK, Radom (PL)

(21) Appl. No.: 17/270,024

(22) PCT Filed: Aug. 11, 2019
(86) PCT No.: PCT/EP2019/071518

§ 371 Date: Feb. 21, 2021

(30) Foreign Application Priority Data
Aug. 22, 2018 (EP) 18461602.7

(51) Int. Cl. A62C 13/76; A62C 99/00; A62C 13/62

(52) U.S. Cl. CPC A62C 13/76; A62C 13/62; A62C 99/0072

(57) ABSTRACT

A low-pressure mist fire extinguishing device for generating a mist stream as a result of a two-phase flow generated from a gas and a liquid A pressure tank is filled with the liquid and the gas and closed with a valve assembly. A mixer for generating the two-phase flow of the liquid and the gas has an inlet section and the outlet section. At least one outlet nozzle is connected at an outlet side of the valve assembly. In the recommended vertical position of the device, the mixer is located in a space of the tank which is filled with the gas, above a surface of the liquid.

### TECHNICAL FIELD

The present disclosure relates to fire extinguishing devices, in particular of a low-pressure mist fire extinguishing device that generates a stream of mist from a two-phase flow of a gas and a liquid generated within the device. The disclosure also relates to a set of components for the fire extinguishing device. The disclosure relates both to portable, transportable fire extinguishing devices as well as to stationary fire extinguishing devices.

### BACKGROUND

Various extinguishing agents are used to combat fires. These measures should be effective, cheap and above all ecological. Water is the best measure to meet the above requirements. The extinguishing action of water consists in stopping the burning process by lowering the temperature and reducing the oxidant in the combustion zone. Lowering the temperature is possible due to the large thermal capacity of the water, the total cooling surface and the high evaporating temperature of the water. The reduction of the amount of oxygen in the burning zone is due to the rapid evaporation of water. The more shredded the water, the greater the area of cooling. Water in the form of a mist has a much more developed cooling surface, which significantly increases the evaporation capacity, i.e. it cools faster and more rapidly limits the access of oxygen. In addition, high-energy water mist easily reaches the source of the fire and creates a thin layer on the surface of the material, reducing the spread of fire. In addition, the water that has not evaporated spreads and adheres to the surface of the slaked material, reducing the spread of the fire.

In firefighting tactics, the extinguishing agent can fed to the fire area in a form of a solid stream, a droplet stream or a mist stream. The best fire extinguishing effect is achieved by means of the mist stream. There are two types of fire extinguishing methods: spot fire extinguishing, wherein the stream is directed towards the source of fire and volume fire extinguishing, wherein the entire volume of the room in fire is filled with a mist. In case of the spot fire extinguishing, the mist should have a high energy, a high density and the drops should have a diameter smaller than 100 μm. In case of volumetric fire extinguishing, the mist should have a very high density and the drops should have a diameter smaller than 40 μm in order fill the room entirely. The mist generated from water, in particular from distilled water, is a very universal and environment-friendly fire extinguishing agent due to minimal post-fire losses and no pollution caused to the environment. The stream of mist is suitable for extinguishing fires of almost all classes (except of flammable materials that react with water), including solids, flammable liquids, flammable gases and edible fats. The mist may be also utilized for extinguishing devices under electrical fire and living organisms, including people. The mist has very good cooling properties and does not cause a thermal shock (it decreases the risk of cracking of the heated elements). The extinguishing properties of the mist may be further significantly expanded by adding to the water small amounts of agents for decreasing the freezing temperature and surface tension.

The mist for firefighting purposes can be generated either by high-pressure or low-pressure devices. The high-pressure mist stream is used in transportable and stationary extinguishing devices, whereas the low-pressure mist stream can also be used in portable (handheld) devices, which are suitable for extinguishing fire in its initial phase. The difficulty encountered in the design of low-pressure portable extinguishing devices is to maintain a high extinguishing capability during unloading of the extinguisher, i.e. at violently falling pressure. Moreover, fire extinguishing devices for fighting fires in their initial phase should be designed such that in the first phase after start-up they supply a large amount of extinguishing agent to suppress the fire, while in the final phase the amount of the agent may be decreased for the final stage of fire extinguishment.

The mist stream suitable for extinguishing fire in its initial phase should have small drops of a high energy (in order to thoroughly penetrate the area of fire) and a shape of a cone of high density (in order to provide a large cooling area), with an average application rate, depending on the situation, from 6 to 15 l/min. The mist stream of such properties may be obtained by means of high-pressure devices, which are known in the state of the art, but are relatively expensive and due to their specific features are not suitable for application in hand-held extinguishing devices.

In the currently used solutions for low-pressure devices, various types of improvements are applied, especially in the field of mixers, which aim to increase the energy and the density of the generated mist stream. However, the efficiency of these solutions is significantly lower than the efficiency of the high-pressure devices.

A PCT application WO2017160173 discloses a device ensuring a two-phase flow in a liquid atomiser, equipped in its upper part with a discharge control assembly. The device contains at least one egress channel, as well as a plunger tube, placed below this assembly and interconnected with this assembly, the plunger tube having in its lowermost section an ingress channel, optionally outfitted with a filter to keep away impurities, and interconnected with a discharge control assembly, and further downstream with an egress channel, wherein the plunger tube is outfitted with a liquid flow restrictor and, above the latter, a row of side openings connecting external space of the tube with its inner channel where the successive side openings are positioned longitudinally along the tube at different distances from the restrictor. In that device, the perforated tube functions as a mixer, and it is fully filled with liquid, to which only some gas is drawn through the perforations. Therefore, the tube is filled with a continuous stream of liquid to which the gas is injected via an injection effect through side perforations in the tube which are located above the surface of the liquid. Consequently, the mixing capabilities of that arrangement vary as the surface of the liquid lowers. In that device, there is no chamber in which an underpressure could be formed (only some underpressure may form locally, according to Reynold's law, only in the vicinity of the perforations).

Therefore, there is a need to further improve the design of the low-pressure fire extinguishing devices, in order to generate a mist stream of a higher energy and density, preferably to achieve within the low-pressure devices the efficiency available so far in the high-pressure devices.

### SUMMARY

There is disclosed herein a low-pressure mist fire extinguishing device for generating a mist stream as a result of a two-phase flow generated by the device from a gas and a liquid. The device comprises a pressure tank filled with the liquid and the gas and closed with a valve assembly; a mixer connected by its outlet section to an inlet side of the valve assembly, for generating the two-phase flow of the liquid and the gas; at least one outlet nozzle connected at an outlet side of the valve assembly, the outlet nozzle comprising at least one set of outlet ducts arranged in a colliding manner with respect to each other. The mixer has an inlet section comprising: liquid ducts terminated with liquid openings, wherein the liquid ducts are connected with the pressure tank through a hydrophore tube; and gas ducts terminated with gas openings, wherein the gas ducts are connected to the pressure tank. In the recommended vertical position of the fire extinguisher, the mixer is located in a space of the tank which is filled with the gas, above a surface of the liquid. The mixer has a chamber between the inlet section and the outlet section, wherein separate streams of gas from the gas openings intersect with separate streams of liquids from liquid openings when the device is in use. The outlet ducts of at least one outlet nozzle have outlet openings of a total cross-sectional area that is larger than a total cross-sectional area of the liquid openings of the mixer.

An axis of the liquid duct and an axis of the gas duct may be convergent in the chamber of the mixer.

The axis of the liquid duct and the axis of the gas duct may intersect each other.

The axes of all gas ducts in the mixer may be convergent to an axis of the mixer.

The liquid opening may have a form of a slot.

The gas opening may be located in a longitudinal axis of symmetry of the liquid opening.

The liquid openings may be circular and arranged next to each other along radial lines radiating from axis of the mixer.

The gas opening may be located in an axis of the arrangement of the liquid openings.

The liquid openings and the gas openings may be arranged along radial lines radiating from the axis of the mixer.

A diameter of the chamber of the mixer may be greater than the outlet and the inlet of the mixer.

The total cross-sectional area of the outlet openings of the outlet ducts of at least one outlet nozzle may be at least 20% larger than the total cross-sectional area of the liquid openings of the mixer.

There is also disclosed herein a set of components for a low-pressure mist fire extinguishing device having a valve assembly, the set comprising: a mixer having an outlet section for mounting at an inlet side of the valve assembly of the fire extinguishing device; at least one outlet nozzle for mounting at an outlet side of the valve assembly of the fire extinguishing device; the outlet nozzle comprising at least one set of outlet ducts arranged in a colliding manner with respect to each other. The mixer has an inlet section comprising liquid ducts terminated with liquid openings and gas ducts terminated with gas openings. The mixer has a chamber between the inlet section and the outlet section, wherein streams of gas from the gas openings may intersect with streams of liquids from liquid openings. The outlet ducts of at least one outlet nozzle have outlet openings of a total cross-sectional area that is larger than a total cross-sectional area of the liquid openings of the mixer.

The total cross-sectional area of the outlet openings of the outlet ducts of at least one outlet nozzle may be at least 20% greater than the total cross-sectional area of the liquid openings of the mixer.

The fire extinguishing device as disclosed herein has a simple design and it can produce a dense and stable mist streams from various types of liquids. One advantage of the presented device is that it generates, from a two-phase flow of a liquid and a gas, a mist stream with very fine drops, having a relatively high energy, in the entire range of operating pressure of the device. The presented device may be utilized for portable (hand-held) extinguishing devices (fire extinguishers), transportable fire extinguishing devices (extinguishing aggregates), or stationary fire extinguishing devices. The mist stream generated by the device is particularly useful for extinguishing fire in its initial phase.

### BRIEF DESCRIPTION OF DRAWINGS

The devices are presented herein by means of example embodiments on a drawing, wherein:

FIG. 1 presents schematically a fire extinguishing device;

FIG. 2 presents a longitudinal cross section of a mixer of the fire extinguishing device of FIG. 1;

FIG. 3 presents a cross-section of the mixer of FIG. 2;

FIG. 4 presents a cross-section of the mixer with an alternative arrangement of openings in the mixer;

FIG. 5 presents a cross-section of an outlet nozzle;

FIG. 6 presents a plate of the outlet nozzle in an isometric view;

FIG. 7 presents the plate of the outlet nozzle in a side view;

FIG. 8 presents a cross-section along outlet ducts of the nozzle of FIG. 6.

FIG. 9-11 present an alternative embodiment of the outlet nozzle.

### DETAILED DESCRIPTION

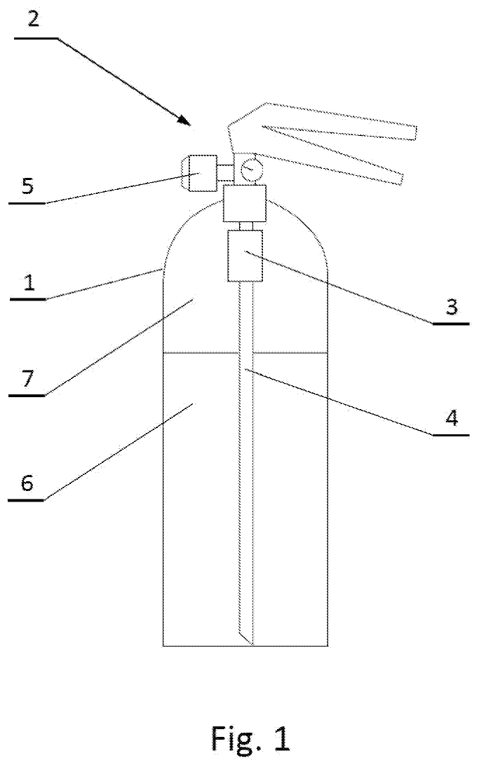

A fire extinguishing device is presented by means of an example in a form of a fire extinguisher in FIG. 1. It comprises a pressure tank 1, an outlet nozzle 5, a valve assembly 2, a mixer 3, and a hydrophore tube 4 equipped with a particles filter. The mixer 3, located inside the pressure tank 1, is connected to the valve assembly 2 at the side of an inlet of the valve assembly 2. The hydrophore tube 4 extends to a bottom of the pressure tank 1 and is connected to the mixer 3. The outlet nozzle 5 is connected to an outlet of the valve assembly 2. The outlet nozzle 5 comprises at least one set of outlet ducts 23, 24 (as presented in FIG. 8) arranged with respect to each other in a colliding configuration, i.e. paths of propagation of drops ejected from these ducts intersect, which results in that the drops collide with each other and are further fragmented. The outlet nozzle 5 may be mounted directly on the valve assembly 2, as shown in FIG. 1, or indirectly by means of a hose. The pressure tank 1 is filled with a liquid 6, and the volume above that liquid is filled with gas 7.

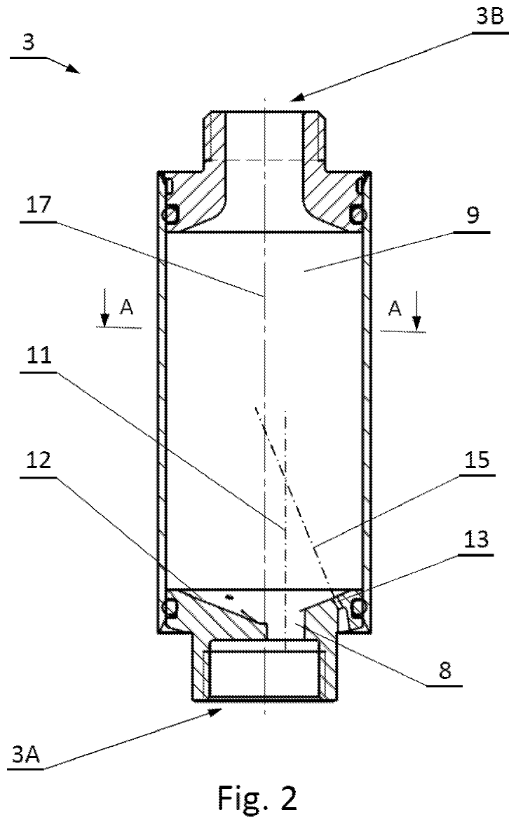

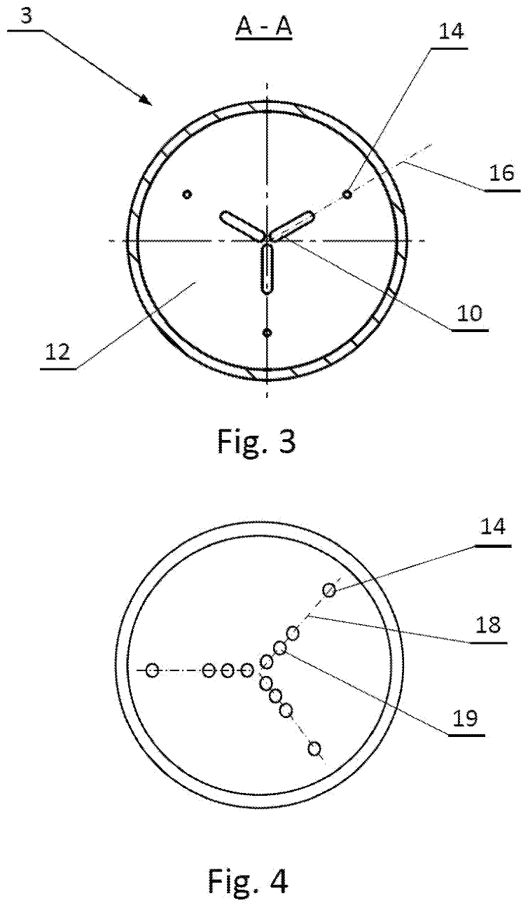

The mixer 3 has a form of a cylinder (as shown in FIG. 2). Preferably, the inner diameter of the mixer 3 is greater than the diameters of the inlet and the outlet of the mixer. In an inlet section 3A of the mixer 3 there are located liquid ducts 8, which are connected at one side with the hydrophore tube 4 to allow flow of liquid. At the other side, the liquid ducts 8 are connected to a chamber 9 of the mixer 3 and are terminated with liquid openings 10 in the chamber 9 (FIG. 3). As in the presented embodiment, the liquid openings 10 may have a form of slots, or may be circular or may have any other shape, which is selected to form a cross-sectional shape of a liquid stream directed to the chamber 9 from the particular liquid opening 10. Therefore, a separate stream of liquid is generated from each liquid opening 10 into the chamber 9 (i.e. separate from the other streams of liquid and from the streams of gas). Generally, it may be assumed that the liquid stream is directed along an axis 11 that passes through a geometrical center of the liquid duct 8 and the liquid opening 10. In case the liquid opening 10 has a form of a slot, a flat stream of liquid is formed. When the liquid is supplied at constant pressure, the flow rate of the liquid flowing to the chamber 9 depends on a cross-sectional area of the liquid opening 10. In the embodiment of FIG. 2, in the inlet section 3A on a bottom conical surface 12 of the chamber 9, there are located three slot liquid openings 10 that are arranged radially, wherein these slot opening may have a width from 0.5 to 1 mm and a length that is 2 to 10 times of the width. In the inlet section 3A of the mixer 3 there are also located gas ducts 13, which at one side are connected with the tank 1 to allow gas flow—in particular, they are connected to the volume located above the liquid 6, that is filled with the gas 7. At the other side, the gas ducts 13 are connected to the chamber 9 and are terminated, at the bottom surface 12, with gas openings 14. Therefore, a separate stream of gas is generated from each gas opening 14 into the chamber 9 (i.e. separate from the other streams of gas and from the streams of liquid). Similarly, an axis 15 may be determined for the gas opening 14, which substantially passes through a geometrical center of the gas opening 14 and coincides with the axis of the gas duct 13, wherein the axis 15 sets the direction of a gas stream flowing to the chamber 9. The gas opening 14 may have a diameter from 0.5 to 1 mm. The axes 11 and 15 are convergent, i.e. they are positioned at a small angle with respect to each other. The axes 11 and 15 may intersect each other or may pass close each other, so that the stream of the gas intersects the stream of the liquid at some distance from the liquid openings 10 and from the gas openings 14.

In the presented embodiment, the arrangement of the liquid openings 10 and of the gas openings 14 is such that the gas opening 14 is located on the axis of symmetry 16 of the liquid opening 10. The presented arrangement of the pair of gas openings 14 and liquid openings 10 is radial, i.e. an axis of symmetry 16 of the liquid opening 10 passes through an axis of symmetry 17 of the mixer 3. It is possible to provide a higher number of smaller openings. It is also possible to provide slot liquid openings 10 in any other non-radial arrangement. Moreover, it is also possible to locate several circular openings 19 on an axis 18, on which the gas opening 14 is also located, as presented in FIG. 4.

The mixer may be connected to the hydrophore tube 4 by means of a threaded connection, wherein the connection of the hydrophore tube 4 with the mixer 4 is sealed. In front of the mixer 3 inlet, a particle filter (not shown) integrated with the hydrophore tube can be located. An outlet section 3B of the mixer may also be connected to the valve assembly 2 by means of the threaded connection.

The aforementioned design of the mixer forms a universal structure and may be utilized in different kinds of single-bottle, low-pressure fire extinguishing devices, wherein a suitably large volume for the gas is available (preferably, at least 30% of the volume of the bottle), so that the mixer, when the fire extinguisher is in a rest position and in an operating position, is located in the space with the gas above the level of the liquid and is connected by the hydrophore tube that reaches to the bottom of the tank.

In a vertical position of the fire extinguishing device, as presented in FIG. 1 (i.e. in the position in which the fire extinguisher is supposed to be stored (rest position) and operated (operating position)), the mixer 3 is located in the space filled with the gas 7, above the liquid 6. Owing to this, during the storage of the fire extinguisher, any possible contaminants of the liquid (mechanical or biological) are not in contact with the mixer. This limits the risk of the liquid ducts 8 and the gas ducts 13 in the mixer 3 being blocked by these contaminants. Therefore, the mixer maintains its high efficiency during a long time, and does not require cleaning.

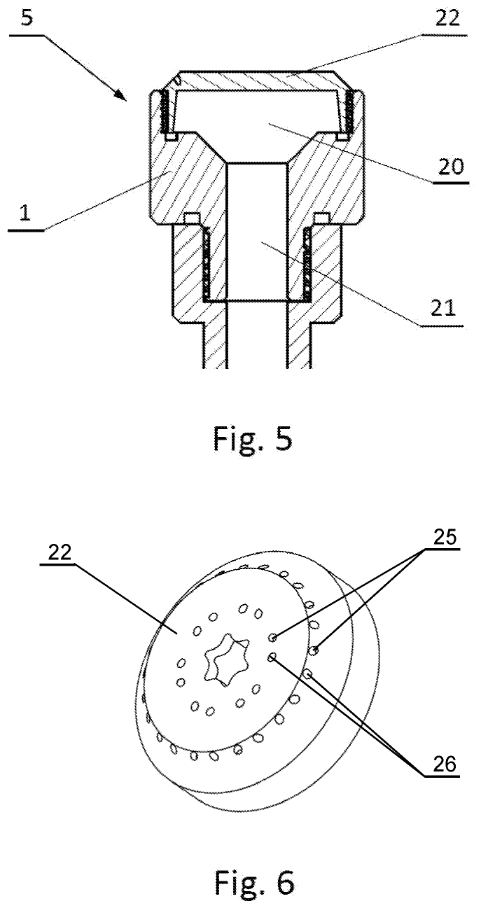

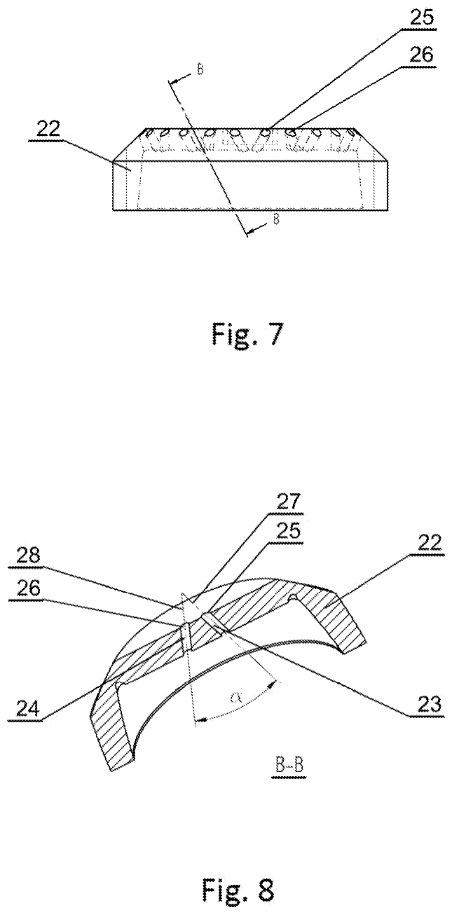

The outlet nozzle 5, as presented in FIG. 5, has a chamber 20 to which a two-phase flow is introduced from the mixer through the valve assembly 2 through a duct 21. The nozzle is terminated by a plate 22 having multiple outlet ducts 23, 24 arranged with respect to each other in a colliding configuration, preferably arranged in sets of two ducts (i.e. in pairs). Preferably, the sets of the ducts 23, 24, arranged with respect to each other in a colliding configuration, are arranged circularly on an outer surface, as presented in FIGS. 6 and 7, wherein outlet openings 25, 26 of the outlet ducts 23, 24 are shown. FIG. 8 presents a cross-section across the pair of outlet ducts 23, 24 terminated with the outlet openings 25, 26. The drawing shows axes 27, 28 of the outlet ducts, which set directions of the mist drops that are output from the two-phase flow from the chamber 20. By selecting an angle of collision a, at which the axes 27, 28 of the outlet ducts 23, 24 intersect, a desired range and density of the mist stream may be obtained—the lower the collision angle α, the higher the range and the higher the density is.

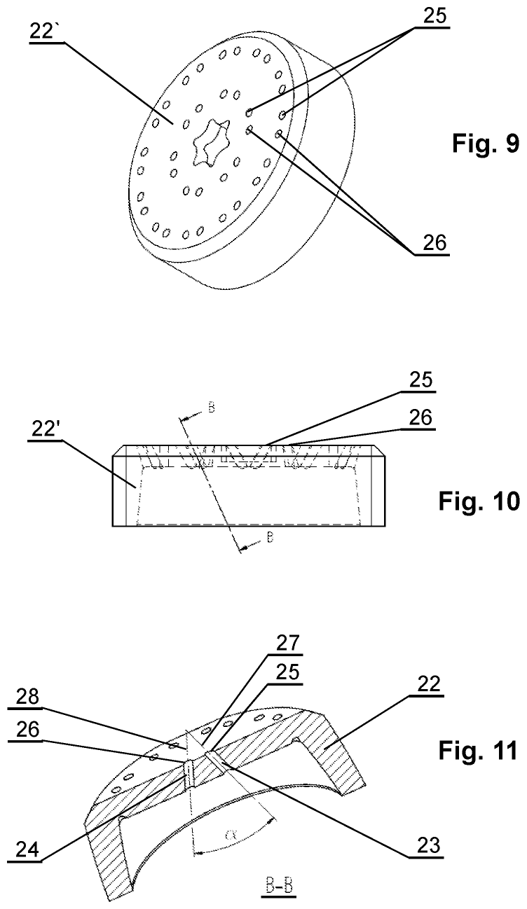

FIGS. 9-11 present, similarly to FIGS. 6-8, an alternative embodiment of the outlet nozzle, which differs from the embodiment of FIGS. 6-8 essentially in that the plate 22′ is flattened, which may be more convenient to manufacture.

For a certain pressure inside the chamber 20, the intensity of the mist stream output from the outlet nozzle 5 depends on a cross-sectional area of the outlet openings 25, 26 of the outlet ducts 23, 24. The total cross-sectional area of the outlet openings 25, 26 of all outlet ducts 23, 24 is greater than the total cross-sectional area of all liquid openings 10, 19 through which the liquid is delivered to the chamber 9 of the mixer 3. Thereby, the pressure in the volume between the liquid openings 10, 19 and the outlet openings 25, 26, in particular in the volume inside the mixer 3, is lower than the pressure surrounding the mixer 3 inside the pressure tank. Therefore, the gas is intensively drawn through the gas ducts 13 into the space inside the mixer 3, which causes high dispersion of gas bubbles in the two-phase flow in the mixer. The highly dispersed gas bubbles have a high influence on ejection of the mist drops with a high intensity through the outlet ducts 23, 24 in the outlet nozzle 5. So-called piston flow occurs in the outlet ducts. Due to a small diameter of the ducts, the drops of water in the duct are separated by the gas bubbles and on the outlet of the duct the consecutive drops are ejected, wherein the intensity of the mist drops ejection depends on the pressure inside the mixer 3, which depends on the cross-section area of the nozzle 5 outlet openings 25, 26 and the liquid openings 10, 19 of the mixer 3.

The pressure tank is filled with the fire extinguishing liquid 6 and with the gas 7. The liquid should be inflammable and have a low viscosity. For example, water may be used as the fire extinguishing liquid, preferably distilled water. The gas should be an inert gas, for example nitrogen. The gas 7 is used for generating the two-phase flow and for displacing (pushing) the fire extinguishing liquid 6 through the hydrophore tube 4 to the mixer 3 and further to the valve assembly 2. The liquid phase dispersion is effected in multiple stages. In the mixer 3, the dispersion of the liquid phase occurs as a result of the liquid stream dispersion caused by the gas stream directed towards the liquid stream, owing to which the two-phase flow is generated in the mixer. When the axis of the gas stream is convergent to the axis of the liquid stream or it intersects the axis of the liquid stream, then it leads to an efficient dispersion of the liquid stream drawn from the liquid ducts. In the presented embodiment, the liquid stream output from the opening 10, having a form of a slot, is flat, has a plane of symmetry, and is dispersed by means of the gas stream having an axis 15 that is in the plane of the liquid stream. Such dispersion is more efficient than dispersing the stream of the liquid having a circular cross-section. The resulting mixture of the liquid and the gas, being initially dispersed, is transferred in a turbulent manner to the chamber 20 of the nozzle 5, wherein the drops of the liquid and the gas enter the outlet ducts 23, 24, in which the water drops move alternately with the gas bubbles. The energy of ejection of the drops from the outlet openings 25, 26 of the outlet ducts 23, 24 is intensified by compression of the gas bubbles following the liquid drops in the duct 23, 24. In other words, in the outlet ducts 23, 24 the liquid drops and the gas drops are arranged alternately, wherein the gas drops act as elastic pistons which eject, with a high energy, the liquid drops out of the nozzle. Owing to the fact that the openings in the outlet plate of the nozzle are directed in pairs to each other, as a result of collision, the ejected drops are broken into even smaller drops, which results in a further fragmentation of the mist stream generated by the nozzle.

Therefore, the outlet nozzle 5 operates as a bubble nozzle due to a high proportion of the gas which is intensively drawn in the two-phase flow generated in the mixer 3. The two-phase flow is transferred to the plurality of outlet ducts 23, 24 in the nozzle 5, thereby the liquid drops are not accumulated. The final fragmentation is effected outside the nozzle 5, when the streams ejected from the outlet ducts 23, 24 of the nozzle 5 collide with each other. By increasing the collision angle α, smaller drops and a wider cone of the stream may be obtained, thereby decreasing the energy of the stream. Such solution is useful in stationary low cubature fire extinguishing devices, wherein high ranges of the stream are not required, for example in various engine chambers, control cabinets etc. Lower angles of collision can be used in larger rooms.

The efficiency of a fire extinguishing device depends on a structure of the mixer, namely on an arrangement and a size of the liquid and gas openings, as well as on the structure of the outlet nozzle, namely on the degree of dispersion of the two-phase flow and on the size of the openings 25, 26 in the outlet ducts 23, 24. The technical parameters of the mixer and the nozzle are related to each other.

It is particularly advantageous if the cross-sectional area of the outlet openings 25, 26 is at least 20% larger than the cross-sectional area of the outlet openings 10, 19 in the mixer 3. In such a case (for 20%), the total cross-sectional area of the liquid openings 10, 19 should be equal to

$$p = \frac{π {r}^{2} * n}{1.2}$$

wherein:
p is the total cross-sectional area of the liquid openings 10, 19,
r is the radius of the outlet opening 25, 26,
n it the number of the liquid openings 25, 26.
   The number and the diameters of the gas ducts depend on the total cross-sectional area of the liquid openings 10, 19. For example, for the mixer having external dimensions: the diameter of 28 mm and the height of 40 mm, the gas openings may be selected as follows:
for p≤10 mm²-3 openings, each having a diameter of 0.5 mm
for p in the range from 10 to 15 mm²-3 openings, each having the diameter of 0.6 mm
for p≥15 mm²-3 openings, each having the diameter of 0.7 mm

Additionally, the gas flow to the liquid may be adjusted by the number of the openings and their arrangement.

The size of drops in the mist stream depends on the diameter of the nozzle outlet openings 25, 26 and the collision angles of the outlet nozzle. The lower the diameter and the higher the collision angle, the smaller the drops are. For example, it is preferable to use the outlet openings 25, 26 having a diameter equal to 0.7 mm or 0.8 mm and the collision angles from 40° to 90°.

The density of the mist stream depends on the number of nozzle outlet ducts and on the size of drops.

In alternative embodiments, the fire extinguishing device, in particular in stationary fire extinguishing installations, may comprise multiple outlet nozzles 5, for example connected in parallel to a distributor connected to the outlet of the valve assembly 2.

The presented mixer 3 with at least one outlet nozzle 5 may be provided foo manufacturers of fire extinguishing devices as a set of components to be assembled in typical devices. An important advantage of such a set of components is that it is universal and can be mounted in fire extinguishing devices of various sizes to generate a mist of the same parameters. For example, the same set can be mounted in fire extinguishers with different amounts of the fire extinguishing agent, for example from 1 to 12 dm³.

An important parameter of a fire extinguisher is the efficiency of gas utilization—in the presented solution, for a proper gas management it is enough to provide at least 30% of bottle volume for the gas. In the first phase of fire extinguishing, a dense mist stream is generated. At the end of discharge, owing to the hydrophore tube end which is acute, the remaining liquid is pushed out (ejected) from the device in a form of a very dense mist stream with fine drops. Such operation is necessary in the final phase as it prevents output of a liquid having large drops, which could cause thermal shock of heated elements or splashing of heated fats. Such blowing effect significantly reduces post-fire losses.

By using the device as presented herein with water and nitrogen, it is possible to provide an environment-friendly fire extinguishing device, which generates a low-pressure fire extinguishing mist stream (i.e. below 25 bars) with small drops (i.e. with a diameter below 70 microns), high energy (with a range up to 8 meters), high flow rate (up to 15 l/min) and at a low gas use. Such device may effectively fire extinguish fires in their initial phase to prevent their propagation.

1. A low-pressure mist fire extinguishing device for generating a mist stream as a result of a two-phase flow generated by the device from a gas and a liquid, the device comprising:
a pressure tank filled with the liquid and the gas and closed with a valve assembly having an inlet side;
a mixer for generating the two-phase flow of the liquid and the gas and comprising:
an inlet section comprising:
liquid ducts terminated with liquid openings, wherein the liquid ducts are connected with the pressure tank through a hydrophore tube; and
gas ducts terminated with gas openings, wherein the gas ducts are connected to the pressure tank;
an outlet section connected to the inlet side of the valve assembly;
a chamber between the inlet section and the outlet section, in which separate streams of gas from the gas openings intersect with separate streams of liquids from liquid openings when the device is in use;
at least one outlet nozzle connected at an outlet side of the valve assembly, the outlet nozzle comprising at least one set of outlet ducts arranged in a colliding manner with respect to each other and having outlet openings of a total cross-sectional area that is larger than a total cross-sectional area of the liquid openings of the mixer;
wherein in the recommended vertical position of the device, the mixer is located in a space of the tank which is filled with the gas, above a surface of the liquid.

2. The fire extinguishing device according to claim 1, wherein an axis of the liquid duct and an axis of the gas duct are convergent in the chamber of the mixer.

3. The fire extinguishing device according to claim 1, wherein the axis of the liquid duct and the axis of the gas duct intersect each other.

4. The fire extinguishing device according to claim 1, wherein the axis of all gas ducts in the mixer are convergent to an axis of the mixer.

5. The fire extinguishing device according to claim 1, wherein the liquid opening has a form of a slot.

6. The fire extinguishing device according to claim 5, wherein the gas opening is located in a longitudinal axis of symmetry of the liquid opening.

7. The fire extinguishing device according to claim 1, wherein the liquid openings are circular and arranged next to each other along radial lines radiating from an axis of the mixer.

8. The fire extinguishing device according to claim 7, wherein the gas opening is located in an axis of the arrangement of the liquid openings.

9. The fire extinguishing device according to claim 1, wherein the liquid openings and the gas openings are arranged along radial lines radiating from the axis of the mixer.

10. The fire extinguishing device according to claim 1, wherein a diameter of the chamber of the mixer is greater than the outlet and the inlet of the mixer.

11. The fire extinguishing device according to claim 1, wherein the total cross-sectional area of the outlet openings of the outlet ducts of at least one outlet nozzle is at least 20% larger than the total cross-sectional area of the liquid openings of the mixer.

12. A set of components for a low-pressure mist fire extinguishing device having a valve assembly, the set comprising:
a mixer comprising:
an outlet section for mounting at an inlet side of the valve assembly of the fire extinguishing device;
an inlet section comprising liquid ducts terminated with liquid openings and gas ducts terminated with gas openings;
a chamber between the inlet section and the outlet section in which streams of gas from the gas openings may intersect with streams of liquids from liquid openings;
at least one outlet nozzle for mounting at an outlet side of the valve assembly of the fire extinguishing device and comprising at least one set of outlet ducts arranged in a colliding manner with respect to each other and having openings of a total cross-sectional area that is larger than a total cross-sectional area of the liquid openings of the mixer.

13. The set of components according to claim 12, wherein the total cross-sectional area of the outlet openings of the outlet ducts of at least one outlet nozzle is at least 20% greater than the total cross-sectional area of the liquid openings of the mixer.
